(19) United States
(12) Patent Application Publication
(10) Pub. No.: US 2014/0183781 A1
(43) Pub. Date: Jul. 3, 2014

(54) DIE FOR EXTRUDING A PIPE AND METHOD THEROF

(71) Applicant: Deepak Poddar, Karnataka (IN)

(72) Inventor: Deepak Poddar, Karnataka (IN)

(21) Appl. No.: 14/237,294

(22) PCT Filed: Nov. 4, 2011
(86) PCT No.: PCT/IB2011/054915

§ 371 Date: Feb. 5, 2014

(30) Foreign Application Priority Data
Oct. 8, 2011 (IN) 2737/CHE/2011

(51) Int. Cl. B29C 47/22; B29C 47/00

(52) U.S. Cl. CPC B29C 47/22; B29C 47/0023
USPC 264/209.8; 425/466; 29/525.01

(57) ABSTRACT

A die for extruding a pipe includes a die head having an inlet for receiving and a bore for mixing an extrudate, a punch placed axially inside the die head, and a die cavity mounted at an outlet thereof. An outer surface of the die cavity includes flat surfaces at points of contact of a first adjustment structure which includes a plurality of flat end bolts perpendicular to each other positioned around the die cavity for adjusting position of the die cavity. The die further includes an extended orifice shaped as a thin walled tube formed around the orifice, and a second adjustment structure located at a tip of the orifice to distort the orifice for maintaining uniform flow of extrudate, and a plurality of segments are located around the orifice to uniformly distribute the load of the second adjustment structure on to the outer circumference of the orifice.

### CROSS-REFERENCE TO RELATED APPLICATION

The present application is a national stage filing of PCT Patent Application No. WO 2013/021245 A1, filed on Nov. 4, 2011, and entitled AN ADJUSTABLE EXTRUSION DIE AND A METHOD FOR EXTRUDING A PIPE, which claims priority to Indian patent application serial number 2737/CHE/2011 filed on Aug. 10, 2011, the entire contents of which are incorporated by reference.

### TECHNICAL FIELD

Embodiments of the present disclosure relates to a die for extruding a pipe, more particularly the embodiments relates to a die for extruding the plastic pipes.

### BACKGROUND OF DISCLOSURE

The plastic pipes are made as per specification standards which lay down the basic dimensions of the pipe. This may be the minimum and maximum outer diameter, the average outer diameter and minimum and maximum thickness of the pipe wall around the circumference.

The pipe manufacturer would like to make an ideal pipe which has equal thickness throughout the circumference and depending on the company policy within the range in the minimum side or average side. The inconsistency in the thickness on the circumference of the same pipe results in extra material into the pipe which is actually of no use, it does not increases strength of the pipe in any manner but only results in material loss to the manufacturer.

The process of making the thickness even throughout the circumference of the pipe is called centering the pipe. This is done by shifting the cavity with the help of centering bolts around the punch, in such a manner so as to increase or decrease the gap between the punch and the cavity at the die/orifice to change the flow of plastic material to make the ideal pipe as shown in FIG. 1.

For example at the point where the pipe thickness is more, normally diametrically opposite to the point where pipe thickness is less and the cavity is shifted by centering bolts to increase the gap between punch and the cavity where pipe thickness is less and decrease the gap between punch and the cavity where pipe thickness is more. This is basic centering mechanism in the every die head of plastic pipe. However, the perfect or ideal pipe cannot be obtained only by this basic mechanism and this itself is not sufficient.

There are instances when the pipe thickness are high on two opposite places on the pipe circumference as shown in FIG. 1, which cannot be addressed by the conventional method. Further, in the conventional centering mechanism outer surface of the cavity and the ends of the bolts are circular, this leads to the less precision centering of the die cavity over the punch. Because, the circular portions of the die cavity and the bolts tends to slip.

In addition, the pipe manufactured using the conventional method is not precise. Because very large diameter of the cavity has to be shifted by screw threads for making fine adjustments.

Further, there are thermal flow control systems used in the industry, wherein the temperature at various sections is measured and changed so as to change the flow of the plastic material at such sections and finally get an ideal pipe. These systems also have their own limitations and may not work correctly for thin pipes, small diameter pipes, high speed extrusion and they are also very expensive, and not within the reach of every pipe manufacturer.

In light of forgoing discussion, it is necessary to develop a die for extruding a pipe which has a first and second adjustment means to overcome the limitations stated above.

### SUMMARY OF THE DISCLOSURE

The shortcomings of the prior art are overcome and additional advantages are provided through the provision of system and method as claimed in the present disclosure.

Additional features and advantages are realized through the techniques of the present disclosure. Other embodiments and aspects of the disclosure are described in detail herein and are considered a part of the claimed disclosure.

One embodiment of the present disclosure provides a die for extruding a pipe. The die comprising, a die head having an inlet for receiving an extrudate of a thermoplastic material under pressure followed by a bore of predetermined shape for shaping the extrudate. The die further includes a punch placed axially inside a die head, wherein said punch comprises a converging portion followed by a circular portion defining an inside diameter of pipe. And a die cavity at an outlet of the die head having a converging portion followed by an orifice for accommodating the punch. In the present disclosure, outer surface of the die cavity (103) is milled into flat surface at points of contact of a first adjustment means (105), and the first adjustment means comprising four number of flat end bolts perpendicular to each other are provided around the die cavity for adjusting position of said die cavity with respect to the punch. An extended orifice as a thin walled tube protruding from the die cavity outlet. A second adjustment means provided at tip of the extended orifice to distort at predetermined locations of extended orifice to maintain uniform flow of extrudate and thereby obtaining concentric pipe. And plurality of segments of predetermined shape provided around extended orifice to uniformly distribute the load of the second adjustment means on to the outer circumference of the extended orifice. Wherein outer surface of the die cavity is milled into flat surface at points of contact of the flat end bolts to facilitate uniform adjustment of the die cavity.

In one embodiment of the present disclosure, the second adjustment means is an orifice distorting means, selected from at least one of bolt mechanism, hydraulic mechanism and pneumatic mechanism.

Another embodiment of the present disclosure provides a method of adjusting thickness of a pipe. Said method comprising acts of, adjusting a position of die cavity with respect to punch by a first adjustment means to maintain a constant gap between inner circumference of an orifice and an outer circumference of circular portion of the punch. And distorting an extended orifice at predetermined locations by a second adjustment means to maintain uniform flow of extrudate for obtaining concentric pipe.

In one embodiment of the present disclosure, distributing the load of the second adjustment means uniformly on to the outer circumference of the orifice through plurality of segments.

In one embodiment of the present disclosure, adjusting the position of die cavity is carried out by tightening and losing the plurality of flat end bolts provided around the die cavity.

Another embodiment of the present disclosure provides a method of assembling a die for making a pipe. Said method comprising acts of, connecting an inlet of a die head to an outlet of a extruder for passing an extrudate of a thermoplastic material. Placing a punch axially inside a bore of the die head, and mounting a die cavity at an end of the die head, wherein said die cavity accommodates the punch. In the present disclosure, a first adjustment means having a four number of flat end bolts perpendicular to each other are mounted around the die cavity for adjusting position of said die cavity with respect to punch. An outer circumference of the die cavity is milled into flat surface at the points contact of the flat end blots to facilitate uniform contact between flat end blots and die cavity. An extended orifice is created at outlet of the die cavity. A second adjustment means is mounted at tip of the extended orifice to distort predetermined locations of extended orifice for maintaining uniform flow of extrudate and plurality of segments of predetermined shape are provided around the extended orifice to uniformly distribute the load of the second adjustment means on to the outer circumference of the orifice.

In one embodiment of the present disclosure, said extended orifice is thin walled tube protruding from the die cavity outlet.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an extrusion die with conventional centering system.

FIG. 2a illustrates an end view of a die for extruding a pipe according to the present disclosure.

FIG. 2b illustrates a sectional view of the die of FIG. 2a.

FIG. 3a illustrates a sectional view of extended orifice and second adjustment means at tip of the extended orifice according to the present disclosure.

FIG. 3b illustrates an end view of the die of FIG. 3a.

FIG. 4a illustrates exploded view of a die for extruding a pipe, showing a die cavity, first adjustment means and second adjustment means.

FIG. 4b illustrates assembled view of a die for extruding a pipe, showing a die cavity, first adjustment means and second adjustment means.

FIG. 5a illustrates a cross section of pipe made by the extrusion die with conventional centering system.

FIG. 5b illustrates a cross section of ideal pipe having uniform thickness at various points of the pipe circumference.

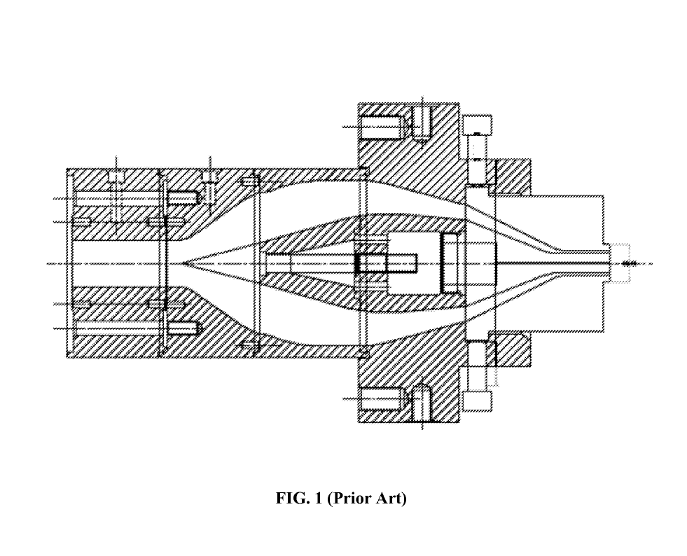

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE PREFERRED EMBODIMENTS

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and descript ion only and is not intended as a definition of the limits of the present disclosure.

To overcome the drawbacks mentioned in the background the orifice of the cavity is modified so as to have a thin section at the orifice and mechanical force is used to slightly distort the orifice in such a manner so as to reduce the flow of material at higher thickness sections and get a pipe which is having least thickness variation.

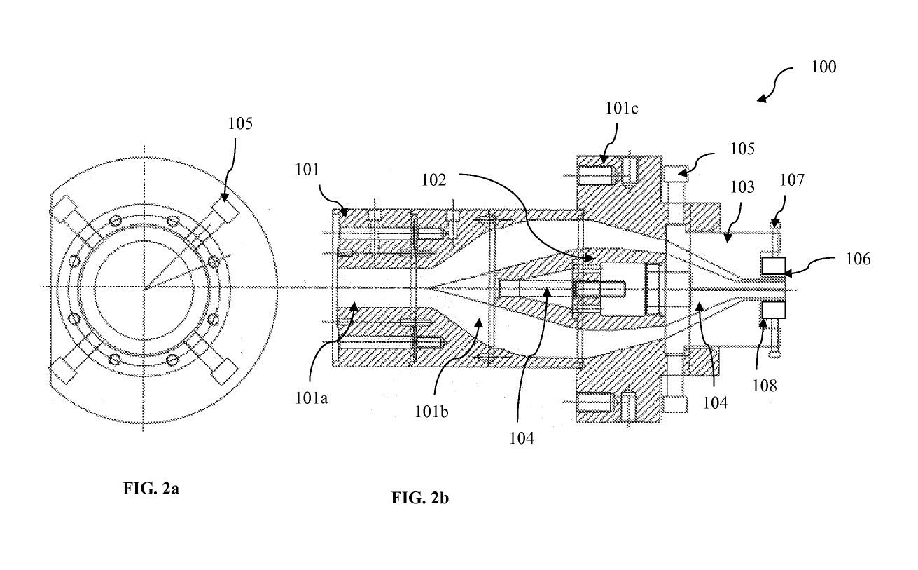

FIGS. 2a and 2b show an exemplary embodiment which illustrates a die (100) for extruding a pipe according to the present disclosure. The die comprises a die head (101) of predetermined shape having an inlet (101a) connected to an outlet of an extruder for supplying an extrudate of a thermoplastic material under pressure, followed by a bore (101b) of predetermined shape for forming the pipe shape. The bore (101b) consists of a diverging section to decrease the velocity of the extrudate to facilitate compaction and pipe formation. A torpedo is placed inside the diverging section of the die head (101) and is supported by a spider portion (101c) of the die head (101). A punch holder (102) placed axially in the direction of flow of extrudate inside a die cavity (103), and said punch holder (102) is supported by a spider portion (101c) of the die head (101). The spider portion (101c) comprises plurality of ribs to firmly hold the punch holder (102) inside the die head (101). A punch (104) having a converging portion (104a) followed by a circular portion (104b) placed axially inside the die head, and is supported by the punch holder (102) or the spider portion (101c) of the head (101). Said circular portion (104b) of the punch (104) forms the inner diameter of the pipe. The die cavity (103) having converging portion (103a) followed by an orifice (103b) is mounted at the end of the die head (101), and the said cavity (103) accommodates the punch (104). The diameter of the circular portion of the punch (104) is less than the diameter of the orifice (103b) of the die cavity (10) and the gap between the two provides the thickness of the pipe to be extruded.

The die (100) further comprises a first adjustment means (105) for adjusting the position of die cavity (103) with respect to punch (104). The first adjustment means (105) comprises 4 flat end bolts placed perpendicular to each other around the die cavity to facilitate centering of the die cavity (101) with respect to the punch (104) to maintain uniform thickness of the pipe. In the existing dies, outer surface of the cavity and the ends of the bolts are circular, this leads to the less precision centering of the die cavity over the punch. Because, the circular portions of the die cavity and the bolts tends to slip. Further, less surface contact between the circular end bolts and die cavity results in indentation on the die cavity which in turn results in inaccurate adjustment. In addition, the existing dies comprises 6-8 bolts for adjustment, which consumes more time for adjustments because more than two bolts need to be tuned for making corrections. Hence, the outer surface of the die cavity (103) in die of the instant disclosure is milled into flat surface at the points of contact of centering bolts to facilitate uniform centering of the die cavity (101). The ends of the centering bolts are flat ends; hence the flat ends of the bolts make uniform contact with the outer surface of the die cavity (103) and results in uniform sliding. Further, number of bolts are reduced to half i.e. 4 in the instant disclosure which results in less time consumption for adjustment, because only lesser number are to be tuned for adjusting thickness in opposite sides.

Further, in the present disclosure a bore is created up to the predetermined extent of the die cavity (101) around the orifice (103b) to form extended orifice (106) as thin section tube. And second adjustment means (107) comprises plurality of distortion mechanisms mounted at tip of extended orifice (106) to distort predetermined locations of the extended orifice (106) to maintain uniform flow of plastic material and thereby obtaining concentric pipe.

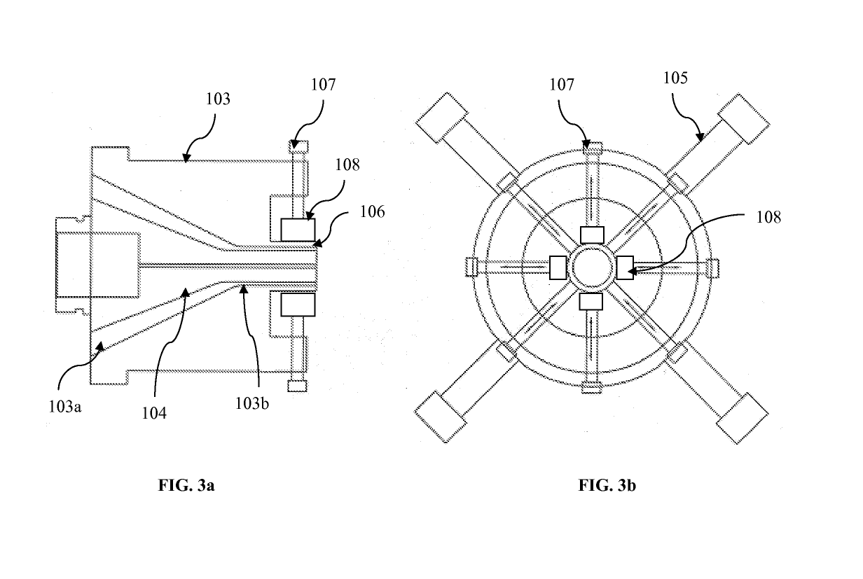

FIGS. 3a and 3b show an exemplary embodiment which illustrates sectional view of extended orifice (106) as thin section around the punch (104) and a second adjustment means (107) at tip of extended orifice (106) according to the present disclosure. The thin section around the orifice may be referred as cantilever. And second adjustment means (107) can be referred as orifice distortion means. The second adjustment means (107) comprises plurality of distortion mechanisms mounted at tip of extended orifice (106) to distort predetermined locations of the extended orifice (106) to maintain uniform flow of plastic material and thereby obtaining concentric pipe. A plurality of segments (108) of predetermined shape is provided around the extended orifice (106) to distribute the load of second adjustment means (107) on to the extended orifice (106) for distorting. In one embodiment of the present disclosure, the shape of segments (108) is selected from group comprising but not limited to rectangular, square. A keeper plate (109) is connected at the tip of the die cavity (103) to hold the segments (108) firmly around the extended orifice (106). In one embodiment, the distortion mechanism is selected from a group comprising but not limited to bolt mechanism, hydraulic mechanism and pneumatic mechanism.

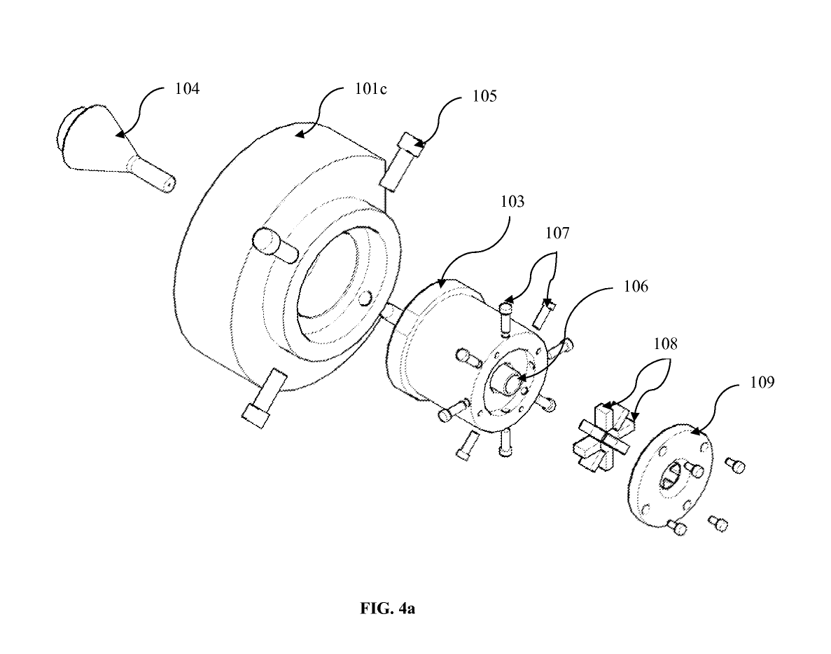

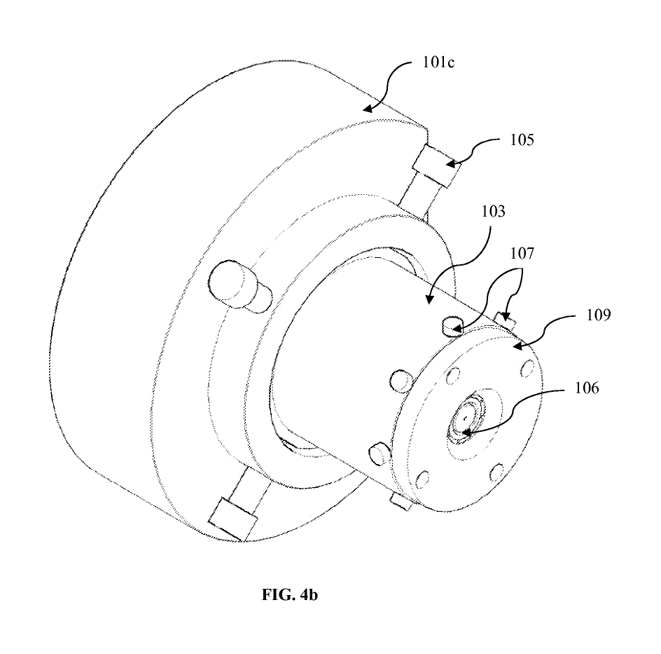

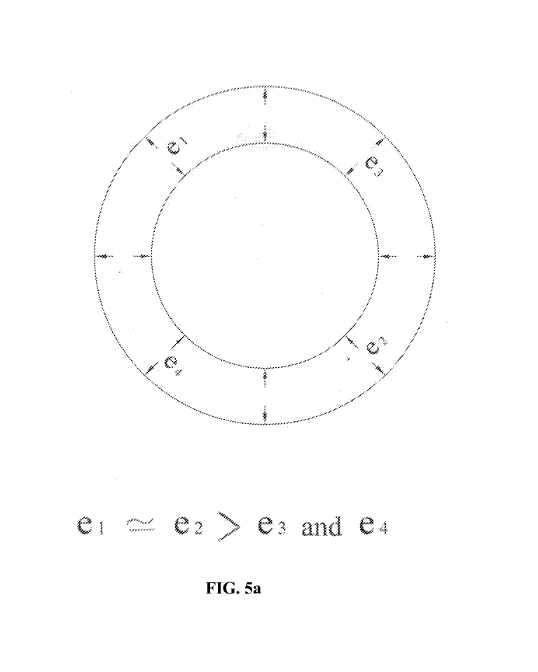

FIG. 4a is an exemplary embodiment which illustrates an exploded view of a die (100) for extruding a pipe, showing a die cavity, first adjustment means and second adjustment means. According to present disclosure, the die (100) can be adjusted using first (105) and second adjustment means (107) to obtain concentric pipe.

The first adjustment means (105) includes 4 number of flat end bolts at 90 degree to each other i.e. perpendicular to each other around the die cavity to adjust the position of die cavity (103) with respect to the punch. The outer circumference of the die cavity (103) is milled into flat surface at the point of contact of flat end bolts to move the die cavity (103) precisely with respect to punch (104). The die cavity (103) can be adjusted by tightening and loosening the flat end bolts.

The second adjustment means (107) includes plurality of distortion mechanisms around the extended orifice (106) to distort the extended orifice to maintain uniform flow of the plastic material. Plurality of segments (108) is provided around the extended orifice (106) to uniformly distribute the load applied by the distortion mechanisms onto the extended orifice.

In one aspect of the present disclosure, the distortion mechanism includes plurality of bolts around the extended orifice (106) to distort the extended orifice at predetermined location to maintain the uniform flow of plastic material. The bolts are tightened to apply the load on segments (108) and the segments (108) in turn uniformly distribute the load applied by the bolts onto the extended orifice to distort the extended orifice.

FIG. 4b is an exemplary embodiment which illustrates an assembled view of a die (100) for extruding a pipe, showing a die cavity (103), first adjustment means (105) and second adjustment means (107). The die cavity (103) is connected at tip of the die head (101) and the said die cavity (103) accommodates the punch (104). The gap between the punch (104) and an orifice (103b) of the die cavity (103) forms the thickness of the pipe to be extruded. The first adjustment means (105) is mounted around the die cavity (103) to adjust the position of die cavity (103) with respect to punch (104). An extended orifice (106) is created from the end of the die cavity (103) by making a bore around the orifice (103b). The second adjustment means (107) is provided at tip of the extended orifice (106) to distort the extended orifice (106) at predetermined locations for maintaining uniform flow of plastic material. And plurality of segments (108) is provided around the extended orifice (106) to uniformly distribute load onto the extended orifice (106).

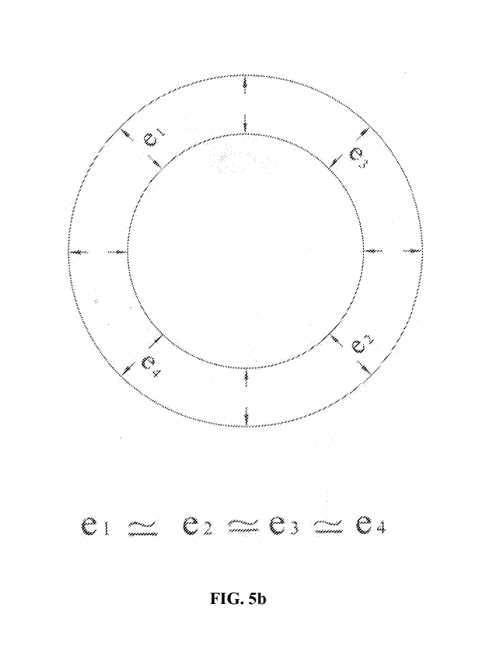

Working of the technology disclosed in the present disclosure is explained with the help of exemplary FIG. 5a. The FIG. 5a illustrates a cross section of pipe having uneven thickness at various points of the pipe circumference. When thickness of the pipe is high on two opposite places on the pipe circumference, the conventional centering mechanism cannot be used because conventional centering tends to increase the thickness at one end while decreasing the thickness at the diagonally opposite end. This would again results in uneven thickness of the pipe circumference. Thus obtaining an ideal pipe alone with the conventional centering mechanism is difficult. Hence, the present disclosure provides a first and second adjustment means (105 and 107) to adjust the position of die cavity (103) with respect to punch and to distort the extended orifice (106) at predetermined locations to make a uniform concentric pipe by maintaining uniform flow of plastic material through the gap between punch (104) and the orifice (103b).

FIG. 5b is an exemplary embodiment which illustrates a cross section of pipe manufactured by the die (100) of the present disclosure. The pipe extruded from the die (100) of the present disclosure have uniform thickness throughout the cross section.

One embodiment of the present disclosure provides a method of adjusting thickness of the pipe according to the present disclosure. The method fallows the steps of measuring the thickness of pipe at the portions below the four flat end bolts. Then adjusting position of die cavity with respect to the punch by tuning the flat end bolts of the first adjustment mechanism. Then measuring the thickness of pipe in between the flat end bolts, and adjusting the thickness of those portions by distorting the extended orifice at predetermined locations.

### Advantages:

The present disclosure provides the die for extruding the pipe which has first and second adjustment means, which adjust the position of die cavity with respect to punch and adjust the flow of plastic material respectively to obtain the uniform pipe.

The present disclosure provides the die for extruding the pipe which maintains uniform thickness throughout circumference of the pipe and thereby saves 1%-3% the plastic material to the person who is skilled in the art.

The present disclosure provides the die for extruding the pipe which is simple in construction and easy to manufacture.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Die for extruding pipe |
| 101 | Die head |
| 101a | Inlet of the die head |
| 101b | Bore of the die head |
| 101c | Spider portion of the die head |
| 102 | Punch holder |
| 103 | Die cavity |
| 103a | Diverging portion of the die |
| | cavity |
| 103b | Circular portion of the die |
| | cavity |
| 104 | Punch |
| 105 | First adjustment means |
| 106 | Extended orifice |
| 107 | Second adjustment means |
| 108 | Segments |
| 109 | Keeper plate |

1-7. (canceled)

8. A die for extruding a pipe, comprising:
a die head having an inlet for receiving an extrudate of a thermoplastic material under pressure followed by a bore of predetermined shape for shaping the extrudate;
a punch placed axially in the die head, the punch comprising a converging portion followed by a circular portion defining an inside diameter of pipe;
a die cavity at an outlet of the die head having a converging portion followed by an orifice for accommodating the punch, wherein an outer surface of the die cavity includes a flat surface at points of contact of a first adjustment structure positioned around the die cavity for adjusting position of the die cavity with respect to the punch;
the first adjustment structure includes a plurality of flat end bolts perpendicular to each other, and slidably contacting the flat surfaces of the die cavity;
an extended orifice shaped as a thin walled tube protruding from the die cavity outlet;
a second adjustment structure located at a tip of the extended orifice to distort at predetermined locations of the extended orifice to maintain uniform flow of extrudate and thereby obtaining concentric pipe; and
a plurality of segments of predetermined shape provided around the extended orifice to uniformly distribute the load of the second adjustment structure on to the outer circumference of the extended orifice.

9. The die as claimed in claim 8, wherein the second adjustment structure comprises an orifice distorting structure, selected from at least one of a bolt mechanism, a hydraulic mechanism and a pneumatic mechanism.

10. The die as claimed in claim 9, wherein the plurality of flat end bolts includes four bolts.

11. A method of adjusting thickness of a pipe by a die, the method comprising the steps of:
providing a die head having an inlet for receiving an extrudate of a thermoplastic material under pressure followed by a bore of predetermined shape for shaping the extrudate;
providing a punch placed axially in the die head, the punch comprising a converging portion followed by a circular portion defining an inside diameter of pipe;
providing a die cavity at an outlet of the die head having a converging portion followed by an orifice for accommodating the punch, wherein an outer surface of the die cavity includes a flat surface at points of contact of a first adjustment structure positioned around the die cavity for adjusting position of the die cavity with respect to the punch, wherein the first adjustment structure includes a plurality of flat end bolts perpendicular to each other, and slidably contacting the flat surfaces of the die cavity;
providing an extended orifice shaped as a thin walled tube that protrudes from the die cavity outlet;
providing a second adjustment at a tip of the extended orifice;
providing a plurality of segments of predetermined shape around the extended orifice;
adjusting a position of the die cavity with respect to the punch by the first adjustment structure to maintain a constant gap between an inner circumference of the orifice and an outer circumference of circular portion of the punch; and
distorting the extended orifice at predetermined locations by the second adjustment structure to maintain uniform flow of extrudate for obtaining concentric pipe.

12. The method as claimed in claim 11, further including:
distributing the load of the second adjustment structure uniformly onto the outer circumference of the orifice through plurality of segments.

13. The method as claimed in claim 11, wherein the step of adjusting the position of the die cavity includes tightening and loosening the plurality of flat end bolts.

14. The method as defined in claim 11, wherein the plurality of flat end bolts includes four bolts.

15. A method of assembling a die for making a pipe, the method comprising the steps of:
connecting an inlet of a die head to an outlet of a extruder for passing an extrudate of a thermoplastic material;
placing a punch axially inside a bore of the die head;
mounting a die cavity at an end of the die head, wherein the die cavity accommodates the punch;
mounting a first adjustment structure around the die cavity for adjusting position of the die cavity with respect to the punch, wherein the first adjustment structure includes a plurality of flat end bolts mounted perpendicular to each other;
providing an outer circumference of the die cavity with a flat surface at the points of contact of the flat end bolts to facilitate sliding contact between the flat end bolts and the flat surfaces of the die cavity;
creating an extended orifice at outlet of the die cavity;
mounting a second adjustment structure at a tip of the extended orifice to distort predetermined locations of the extended orifice for maintaining uniform flow of extrudate; and
providing a plurality of segments of predetermined shape around the extended orifice to uniformly distribute the load of the second adjustment structure onto the outer circumference of the extended orifice.

16. The method as claimed in claim 15, wherein the extended orifice is shaped as a thin walled tube which protrudes from the die cavity outlet.

17. The method as defined in claim 15, wherein the plurality of flat end bolts includes four bolts.
